(19) United States
(12) Patent Application Publication
(10) Pub. No.: US 2026/0138862 A1
(43) Pub. Date: May 21, 2026

(54) WEIGHT REDUCTION IN NON-FOAM CUSHION

(71) Applicant: Lear Corporation, Southfield, MI (US)

(72) Inventors: David HALE, Northville, MI (US); Haifeng LIU, Novi, MI (US); Joshua HALLOCK, Warren, MI (US)

(21) Appl. No.: 18/954,691

(22) Filed: Nov. 21, 2024

(51) Int. Cl. B68G 7/02; A47C 7/24; B68G 15/00; D04H 3/005; D04H 3/10

(52) U.S. Cl. CPC B68G 7/02; A47C 7/24; B68G 15/00; D04H 3/005; D04H 3/10; D10B 2505/08

(57) ABSTRACT

Foamless or non-foam cushions having a mesh member comprising a set of filaments of thermoplastic material is disclosed. In various embodiments, each member of the set of filaments is looped and bonded to at least one other member of the set of filaments. In one or more embodiments, the mesh member defines a plurality of lower density sections disposed within a higher density section. Die tools for the making the same are also disclosed.

### TECHNICAL FIELD

The instant disclosure relates to non-foam or foamless filament nonwoven mesh cushion assemblies and manufacturing tools for the same.

### BRIEF DESCRIPTION OF THE DRAWINGS

FIG. 1 is a perspective view of an example of a seat assembly.

FIG. 2 is a front perspective view of a mesh member.

FIG. 3 is a schematic partial cross-sectional view of an example of a manufacturing system for making a filament mesh structure.

FIG. 4 is a bottom view of a first embodiment of a die tool for dispensing a mesh member.

FIG. 5 is a bottom view of a second embodiment of a die tool for dispensing a mesh member.

FIG. 6 is a bottom view of a third embodiment of a die tool for dispensing a mesh member.

FIG. 7 is a bottom view of a template such as for use with a die tool for dispensing a mesh member.

FIG. 8 is a zoomed-in view of a portion of the template of FIG. 7.

FIG. 9 is a cross-sectional schematic view of an embodiment of a tool dispensing a mesh member.

FIG. 10 is a flow chart illustrating a method of making a mesh member.

FIG. 11 is a top view of an embodiment of a mesh member.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word about in describing the broadest scope of the invention. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose in connection with the invention implies the mixtures of any two or more of the members of the group or class are equally suitable or preferred. Molecular weights provided for any polymers refers to number average molecular weight. Description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially,” “generally,” or “about” may be used herein to describe disclosed or claimed embodiments. The terms “substantially,” “generally,” or “about” may modify a value or relative characteristic disclosed or claimed in the present disclosure to signify within manufacturing tolerances and/or within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4. 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

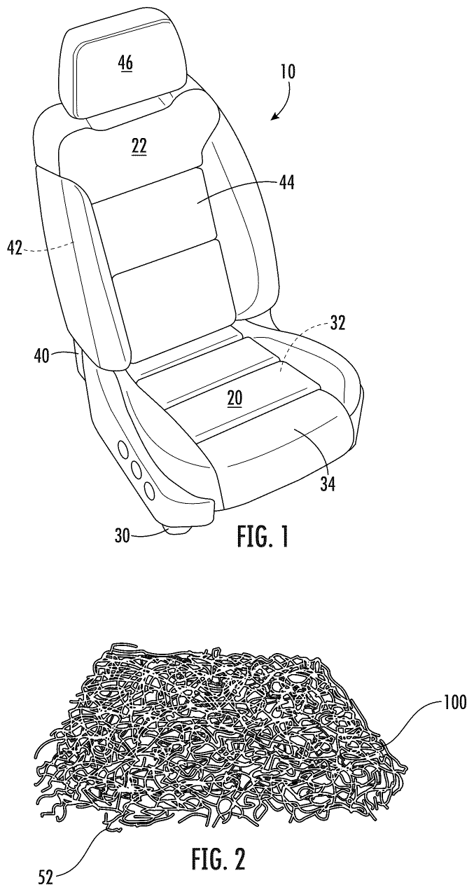

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like an aircraft or a watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool. In one or more embodiments, the seat bottom 20 is configured to receive a seated occupant and support the pelvis and thighs of the seat occupant. In various embodiments, the seat bottom 20 includes a seat bottom frame 30, a cushion 32, and a trim cover 34. In numerous embodiments, the seat bottom frame 30 is a structure that supports the cushion 32. In a variation, the seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed. In one or more embodiments, the cushion 32 is disposed on the seat bottom frame 30. In various embodiments, the cushion 32 is made of a compliant material that supports the seat occupant and distributes load forces from the seat occupant to the seat bottom frame 30.

In various embodiments, the trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. In one or more embodiments, the trim cover 34 is made of any suitable material or materials, such as fabric, leather, leatherette, vinyl, or combinations thereof. In a variation, the trim cover 34 may include a plurality of trim panels that are assembled in any suitable manner, such as by fusing or stitching. In a refinement, the trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad.

In one or more embodiments, the seat back 22 is configured to support the back of a seated occupant. In various embodiments, the seat back 22 is disposed adjacent to the seat bottom 20. For example, the seat back 22 may be disposed above the seat bottom 20 and near the rear side of the seat bottom 20. In a variation, the seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second-row seat assemblies. In one or more embodiments, the seat back 22 includes a seat back frame 40, a cushion 42, a trim cover 44, and optionally a head restraint 46.

In various embodiments, the seat back frame 40 is a structure that supports the cushion 42. In one or more embodiments, the seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

In one or more embodiments, the cushion 42 is disposed on the seat back frame 40. In various embodiments, the cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20.

In one or more embodiments, the trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. In various embodiments, the trim cover 44 is made of any suitable material or materials, such as fabric, leather, leatherette, vinyl, or combinations thereof. In a variation, the trim cover 44 may include one trim panel or a plurality of trim panels that are assembled in any suitable manner, such as by fusing or stitching. In a refinement, the trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

In a refinement, the frame 30 and/or 40 supports other components such as a massaging assembly, a ventilation assembly, a temperature control assembly, a sensor assembly, and/or an electronic assembly. In various embodiments, the seat frame(s) 30 and/or 40 are made of a rigid material (e.g., metal, plastic, wood, or a combination thereof) sufficient to support a seated occupant, and one or more components/subassemblies. For example, a steel and/or aluminum seat frame 30, 40 is used.

In various embodiments, the head restraint 46, if provided, is configured to support the head of a seat occupant. In one or more embodiments, the head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 100 is shown. It is to be understood that the structure and description of the cushion 100 may be applicable to the cushion 32 of the seat bottom 20, the cushion 42 of the seat back 22, and/or any other cushion described herein. In various embodiments, unlike conventional cushions which are generally molded foams, one or more of the cushions are foamless or comprised of a non-foam material such as a plurality of entangled and/or intertwined polymeric filaments 52 defining one or more cushion bodies as depicted in FIG. 2. In other words, portions of the various polymeric filaments are entangled or otherwise bound with portions of other polymeric filaments such that the plurality of polymeric filaments serves as a single unit, piece, cushion, pillow, pad, or mat.

In one or more embodiments, the cushion 100 is a non-foam component or includes at least one non-foam component. The non-foam component is primarily referred to as a mesh member but may also be referred to as a stranded member, looped member, entangled member, filament mesh structure, mesh structure, stranded mesh, looped mesh, entangled mesh, or mesh cushion. In a variation, the cushion 100 is depicted as a non-foam component that does not include a foam component or foam material, such as urethane or polyurethane foam. However, it is contemplated that the cushion 100 may also include a foam component or foam material in addition to a non-foam component to provide additional cushioning or localized cushioning for a seat occupant. For example, foam material may be provided between the cushion 100 and a trim cover (e.g., trim cover 34, 44) that is disposed on the cushion 100, within the cushion 100, or combinations thereof. Reducing the amount of foam material that is provided with the cushion 100 or eliminating foam material from the cushion 100 reduces weight and may improve support and comfort of a seat occupant. In addition, eliminating foam material may facilitate recycling of the cushion 100.

The cushion 100 is described below in the context of a cushion that does not include foam material. In one or more embodiments, the cushion 100 is made of filaments 52 of polymeric material that are randomly looped, bent, curled, or entangled and are bonded together, as shown, for example, in FIG. 2. In a variation, one or more filaments 52 are directly bonded to one or more other filaments 52 rather than being indirectly bonded such as with a resin or other intermediate material.

In various embodiments, the filaments 52, which may also be referred to as strands or threads, are made of any suitable material or materials. In some configurations, the filaments 52 are made of a polymeric material (or molten polymeric material if appropriate for the particular application/invention) such as a thermoplastic material, polymer, and/or resin. For example, the polymeric material may be a polyamide, a polyester, a polyimide, a polyolefin (e.g., polypropylene, polyethylene, etc.), polystyrene, an acrylic, a polyurethane, derivatives thereof, combinations thereof or any other suitable polymeric material. As one example, a polyethylene-based filament may be made of linear low-density polyethylene (LLPDE). In one or more embodiments, the polymeric filament material such as a thermoplastic polymeric material may be recyclable unlike foam materials or may more easily be recycled compared with foam materials. In some embodiments, it is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. In one or more embodiments, it is contemplated that the cushion 100 may include a combination of monofilaments and filaments that are made of multiple materials and are not monofilaments. In various embodiments, filaments 52 that are randomly looped, bent, looped, curled, or entangled and are bonded together where one filament 52 contacts, entangles, and/or is interlocked with another filament 52, thereby resulting in a lightweight, air permeable cushion (e.g., cushion 100) or mesh structure having openings or voids between the filaments 52.

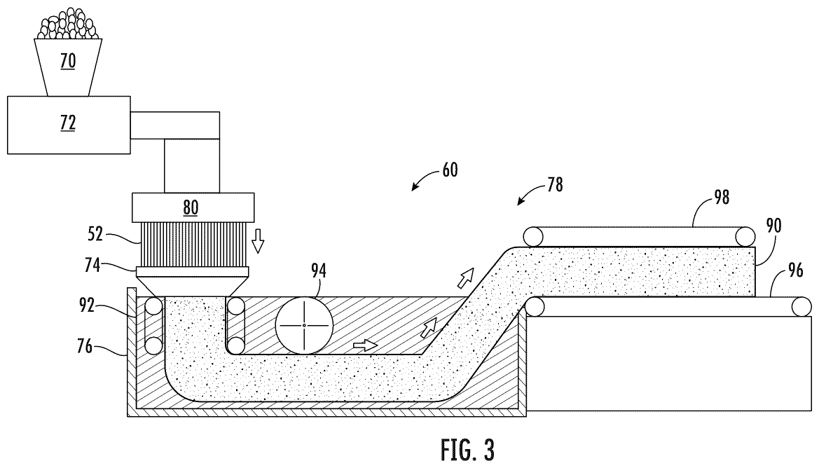

Referring to FIG. 3, an example of a manufacturing system 60 to make a cushion or filament mesh member is shown. In this example, the manufacturing system 60 includes a material supply 70, and one or more tools such as an extruder 72 and/or a funnel 74. In one or more embodiments, the manufacturing system 60 also includes a cooling tank 76 and a material handling subsystem 78. In various embodiments, the material supply 70 holds material stock that is to be extruded, such as solid beads, flakes, granules, pellets, or powder made of the material. In some configurations, the material supply 70 is configured as a container or hopper. In one or more embodiments, the material supply 70 provides material stock to the extruder 72.

In numerous embodiments, the extruder 72 melts the material stock and extrudes the material stock into a set of filaments 52. The extruder 72 may have any suitable configuration. In some configurations, the extruder 72 includes a barrel that receives a rotatable screw and heating elements. In one or more embodiments, rotation of the screw forces the material to move through the barrel and helps heat the material due to the friction generated as the screw rotates. In various embodiments, the material exits the barrel under pressure in a molten state and is transported under pressure to a tool such as die 80 of the extruder 72.

In one or more embodiments, the die 80, which may also be referred to as a die plate, extrusion die, die tool, or tool, has multiple through-holes or filament forming openings (i.e., apertures) through which the molten material passes. For example, the die 80 has a plurality of nozzles defining the through holes or apertures. In various embodiments, a single filament 52 is extruded from each through-hole. In a refinement, the filaments 52 are extruded through the die 80 such that the filaments 52 fall downward from the die 80 under the force of gravity into the funnel 74.

In various embodiments, the funnel 74 consolidates or groups the filaments 52 into a more compact arrangement in which the filaments bend, curl, and/or loop and/or one or more filaments 52 contact and bond to at least one other filament 52. In a refinement, the funnel 74 has an inlet opening or funnel inlet and an outlet opening or funnel outlet that is smaller than the funnel inlet such that individual separated filaments 52 enter the funnel inlet and the filaments 52 bend, curl, loop, and/or move into contact as they accumulate while moving through the funnel 74 toward the funnel outlet. In a variation, some filaments may slide along the funnel 74 or an intervening sheet that is disposed on the funnel 74 as the filaments move toward the funnel outlet. In various embodiments, bonds are formed between filaments 52 at the points of contact while openings or voids between filaments 52 are present at other locations where filament 52 or portions thereof do not contact or bond to another filament 52. In one or more embodiments, the entangled and bonded filaments 52 pass through the funnel outlet of the funnel 74 and enter the cooling tank 76. For convenience, the bonded filaments 52 may be referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively, or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting subsystem of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof.

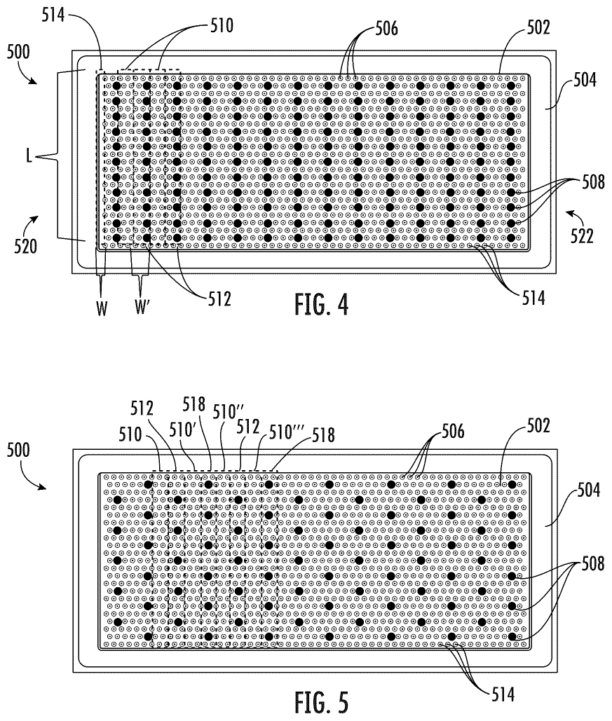

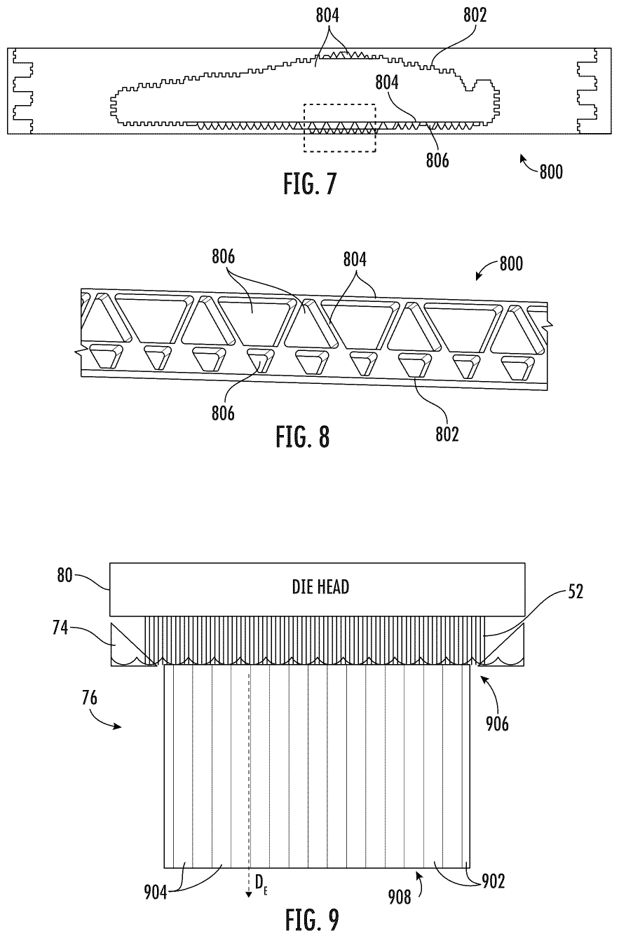

In one or more embodiments, the manufacturing system 60 includes a manufacturing tool comprising a die 500, as shown in FIGS. 4-6. In various embodiments, the die 500 includes a die/tool body 502 within a framed border or periphery 504. In other words, the border, fringe, brim, edging 504 surrounds the tool/die body 502. In a refinement, the tool/die body 502 defines a plurality of apertures 506 (e.g., through-holes) for dispensing a flowable (e.g., molten) polymeric material. In a refinement, the plurality of apertures 506 is unevenly/non-uniformly/non-homogeneously dispersed throughout the tool body 502 or a face thereof. Alternatively, a mask or template 800, as shown in FIGS. 8-9, may be used over a die/tool 500 having evenly/uniformly/homogenously dispersed apertures such that the mask/template blocks certain apertures (i.e., blocked apertures 508) to provide an uneven/non-uniform/non-homogenous dispensing pattern.

Referring to FIG. 4, the tool body 502 defines a plurality of first sections 510 that are different from a plurality of second sections 512. For example, the first sections 510 each have a first pattern of dispensing apertures 514 (e.g., apertures 506 configured to dispense a flowable material such as by not having a template/mask 800 inhibiting dispensing of the material from the aperture 506) and the second sections 512 each have a second pattern of dispensing apertures 514 that is different from the first pattern. In a refinement the first and second sections 510, 512 are arranged intermittently. For example, each second section 512 is intermittently disposed adjacent one or more first sections 510 such as between adjacent first sections 510. In a variation, each first section 510 has no blocked apertures 508, and each second section 512 has one or more (e.g., a plurality of) blocked apertures 508.

In one or more embodiments, a first section 510 has more dispensing apertures 514 than a second section 512 such as an adjacent second section 512 (i.e., the second section 512 has fewer dispensing apertures 514 than a first section 510 such as an adjacent first section 510). For example, each first section 510 has more dispensing apertures 514 than each second section 512 (i.e., each second section 512 has fewer dispensing apertures 514 than each first section 510). In some embodiments, the aggregate number of dispensing apertures 514 for the plurality of first sections 510 is greater than the aggregate number of dispensing apertures 514 for the plurality of second sections 512 (i.e., the aggregate number of dispensing apertures 514 for the second plurality of sections 512 is less than the aggregate number of dispensing apertures 514 for the first plurality of sections 510). For example, the second section 512 (or each second section 512) has at least three fewer apertures, or more preferably at least five fewer apertures, or even more preferably at least ten fewer apertures than a first section 510 (or each first section 510). In one or more embodiments, a first section 510 (or each first section 510) is the same size as a second section 512 (or each second section 512). For example, the first section 510 and second section 512 are defined within different but equivalent areas (e.g., the first section 510 is defined within an area of 1.44 square inches and the second section 512 is defined within an area of 1.44 square inches or each section of both the first plurality of sections 510 and the second plurality of sections 512 is defined within an area of 1.44 square inches). In some embodiments, each first section 510 (or plurality of first sections 510) has the more dispensing apertures 514 than a second section 512 (or the plurality of second sections 512). In a refinement, the second section 512 (or the plurality of second sections 512) has at least 10% less dispensing apertures 514, or more preferably at least 15% less dispensing apertures 514, or even more preferably at least 20% less dispensing apertures 514 than the first section 510 (or plurality of first sections 510).

In some embodiments, the first section 510 (or each first section 510) may have a size that is different than the second section 512 (or each second section 512). In various embodiments, the first section 510 (or plurality of first sections 510) and the second section 512 (or plurality of second section 512) have different concentrations of dispensing apertures 514 (e.g., dispensing apertures 514 per unit area). For example, a first section 510 (or the plurality of first sections 510) has a greater concentration of dispensing apertures 514 than a second section 512 (or the plurality of second sections 512), i.e., the second section 512 (or the plurality of second sections 512) has a lower concentration of dispensing apertures 514 than the first section 510 (or the plurality of first sections 510). In one or more embodiments, a concentration of dispensing apertures may be determined relative to the area of a section. For example, if a first section 516 is defined as a rectangular region having a length (L) of 4.5 inches and a width (W) of 0.16 inches for total area of 0.72 square inches with 23 dispensing apertures it has a concentration of 31.9 dispensing apertures per square inch and if a second section 512 has a length (L) of 4.5 inches and a width (W′) of 0.32 inches for total area of 1.44 square inches with 35 dispensing apertures it has a concentration of 24.3 apertures per square inch such that the concentration of dispensing apertures is greater for the first section 516 compared to the second section 512.

In one or more embodiments, the dispensing apertures 514 are evenly/uniformly/homogenously dispersed in a first section 510 (or plurality of first sections 510) and unevenly/non-uniformly/non-homogenously dispersed in the second section 512 (or plurality of second sections 512). In some embodiments, the dispensing apertures 514 of a first section 510 (or each first section 510) define a first pattern and the dispensing apertures 514 of a second section 512 (or each second section 512) define a second pattern that is different than the first pattern.

In various embodiments, a greater amount of flowable material such as by mass and/or volume is dispensed from a first section 510 than from a second section 512 such as an adjacent second section 512 during operation (i.e., less flowable material, by mass and/or volume, is dispensed from a second section 512 than from a first section 510 such as an adjacent first section 510). In a refinement, a greater amount of flowable material such as by mass and/or volume is dispensed from the plurality of first sections 510 than from the plurality of second sections 512 during operation (i.e., less flowable material by mass and/or volume is dispensed from the plurality of second sections 512 than from the plurality of first sections 510).

In various embodiments, each first section 510 of the plurality of first sections 510 is the same as each of the remaining first sections 510 of the plurality of first sections 510 in all respects except for its position/location along the die/tool body 502 and each second section 512 of the plurality of second sections 512 is the same as each of the remaining second sections 512 of the plurality of second sections 512 in all respects except for its position/location along the die/tool body 502.

Referring to FIG. 5, the tool/die body 502, in some embodiments, defines one or more (e.g., a plurality of third sections 518) that is different than a plurality of first sections 510 and a plurality of second sections 512. For example, the first sections 510 each have a first pattern of dispensing apertures 514 (e.g., no blocked apertures 508 and/or are evenly dispersed dispensing apertures 514), the second sections 512 each have a second pattern of dispensing apertures 514 that is different than the first pattern (e.g., five blocked apertures 508 such that dispensing apertures 514 of this section 512 are unevenly dispersed), and the third sections 518 each have a third pattern of dispensing apertures 514 that is different than the first and second pattern (e.g., six blocked apertures 508 such that dispensing apertures 514 of this section 518 are also unevenly dispersed but dispersed differently than the second sections 512). In some embodiments, each first section 510 has more dispensing apertures 514 than a second section 512 and a third section 518. In a refinement, the second section 512 has at least 3% less dispensing apertures 514, or more preferably at least 5% less dispensing apertures 514, or even more preferably a least 7% less dispensing apertures 514, or still even more preferably at least 10% less dispensing apertures 514 and the third section 518 has at least 5% less dispensing apertures 514, or more preferably at least 7% less dispensing apertures 514, or even more preferably at least 10% dispensing apertures 514, or still even more preferably at least 13% less dispensing apertures 514. In a variation, the second sections 512 have fewer dispensing apertures 514 than the first sections 510, and the third sections 518 have fewer dispensing apertures 514 than the second sections 512.

In various embodiments, each third section 518 and second section 512 are arranged intermittently with each other and the first sections 510 such that each third section 518 is disposed between two first sections 510′, 510″ and each second section 512 is disposed between two first sections 510, 510′ (or 510″, 510′″). In other words, an intermittent pattern of a first section 510, a second section 512, a first section 510, and a third section 518 repeats a plurality of times (e.g., first, second, first, third, first, second, first, third, first, second, first, third...). For example, there is at least two, three, four, five, six, or seven repetitions of the intermittent pattern. It should be understood that the first section 510 and a second section 512 of FIG. 5, may, in combination, also be considered a first section or region and a first section 510′ and third section 518 may, in combination, be consider a different second section or region such that each section/region has unevenly/non-uniformly/non-homogenously distributed dispensing apertures 514. Alternatively, each third section 514 is intermittently arranged amongst the first and second sections 510, 512. In one or more embodiments, each first section 510 may be adjacent a second section 512, and each second section 512 is adjacent a third section 518. For example, a pattern of a first section 510, a second section 512, and a third section 518 may be repeated a plurality of times (e.g., at least three repetitions, at least five repetitions, or at least seven repetitions). In some embodiments, each first section 510 is disposed between a second and third section 512, 518; each second section 512 is disposed between a first and third section 510, 518; and each third section 518 is disposed between a first and second section 510, 512 excluding the sections on the terminal ends 520, 522.

In one or more embodiments, a first section 510 has more dispensing apertures 514 than a second section 512 such as an adjacent second section 512 and a third section 518 such as an adjacent third section 518 (i.e., the third section 518 has fewer dispending apertures 514 than a second section 512 such as an adjacent second section and the second section 512 has fewer dispensing apertures 514 than a first section 510 such as an adjacent first section 510). For example, each first section 510 has more dispensing apertures 514 than each second section 512 and each second section 512 has more dispensing apertures 514 than each third section 518 (i.e., each third section 518 has fewer dispensing apertures 514 than each second section and each second section 512 has fewer dispensing apertures 514 than each first section 510). In some embodiments, the aggregate number of dispensing apertures 514 for the plurality of first sections 510 is greater than the aggregate number of dispensing apertures 514 for the plurality of second sections 512 and the aggregate number of dispensing apertures 514 for the plurality of second sections 512 is greater than the aggregate number of dispensing apertures for the plurality of third sections 518 (i.e., the aggregate number of dispensing apertures 514 for the plurality of third sections 518 is less than the aggregate number of dispensing apertures 514 for the plurality of second sections 512 and the aggregate number of dispensing apertures 514 for the second plurality of sections 512 is less than the aggregate number of dispensing apertures 514 for the first plurality of sections 510). For example, the third section 518 (or each third section 518) has at least one fewer dispensing apertures than the second section 512 (or each of the third sections), and the second section 512 (or each second section 512) has at least three fewer apertures, or more preferably at least four fewer apertures, or even more preferably at least five fewer apertures than a first section 510 (or each first section 510). In one or more embodiments, a first section 510 (or each first section 510) is the same size as a second section 512 (or each second section 512) and a third section 518 (or each third section 518). For example, the first section 510, second section 512, and third section 514 are each defined within different but equivalent areas (e.g., the first section 510 is defined within an area of 1.44 square inches, the second section 512 is defined within an area of 1.44 square inches, and the third section 518 is defined within an area of 1.44 square inches, or each section of the first plurality of sections 510, the second plurality of sections 512, and the third plurality of sections 518 is defined within an area of 1.44 square inches). In some embodiments, each first section 510 (or plurality of first sections 510) has the more dispensing apertures 514 than a second section 512 (or the plurality of second sections 512), and each second section 512 (or plurality of section sections 512) has more dispensing apertures 514 than a third section 518 (or plurality of third sections 518).

In some embodiments, the first section 510 (or each first section 510) may have a size that is different than the second section 512 (or each second section 512) and/or the third section 518 (or each third section 518). In various embodiments, the first section 510 (or plurality of first sections 510), the second section 512 (or the plurality of second section 512), and the third section 518 (or the plurality of third sections) have different concentrations of dispensing apertures 514 (e.g., dispensing apertures 514 per unit area). For example, a first section 510 (or the plurality of first sections 510) has a greater concentration of dispensing apertures 514 than a second section 512 (or the plurality of second sections 512) and the second section 512 (or the plurality of second sections 512) has a greater concentration of dispensing apertures 514 than a third section 518 (or the plurality of third sections 518), i.e., the third section 518 (or the plurality of third sections 518) has a lower concentration of dispensing apertures 514 than the second section 512 (or the plurality of second sections 512) and the second section 512 (or the plurality of second sections 512) has a lower concentration of dispensing apertures 514 than the first section 510 (or the plurality of first sections 510).

In various embodiments, a greater amount of flowable material such as by mass and/or volume is dispensed from a first section 510 than from a second section 512 such as an adjacent second section 512 during operation (i.e., less flowable material, by mass and/or volume, is dispensed from a second section 512 than from a first section 510 such as an adjacent first section 510), and a greater amount of flowable material is dispensed from a second section 512 than from a third section 518 such as an adjacent third section 518 (i.e., less flowable material is dispensed from a third section 518 than from a second section 512). In a refinement, a greater amount of flowable material such as by mass and/or volume is dispensed from the plurality of first sections 510 than from the plurality of second sections 512 during operation (i.e., less flowable material by mass and/or volume is dispensed from the plurality of second sections 512 than from the plurality of first sections 510) and a greater amount of flowable material is dispensed from the plurality of second sections 512 than from a plurality of third sections 518 (i.e., less flowable material by mass and/or volume is dispensed from the plurality of third sections 518 than from the plurality of second sections 512).

In various embodiments, each first section 510 of the plurality of first sections 510 is the same as each of the remaining first sections 510 of the plurality of first sections 510 in all respects except for its position/location along the die/tool body 502, each second section 512 of the plurality of second sections 512 is the same as each of the remaining second sections 512 of the plurality of second sections 512 in all respects except for its position/location along the die/tool body 502, and each third section 518 of the plurality of third sections 518 is the same as each of the remaining third sections 518 of the plurality of third sections 518 in all respects except for its position/location along the die/tool body 502.

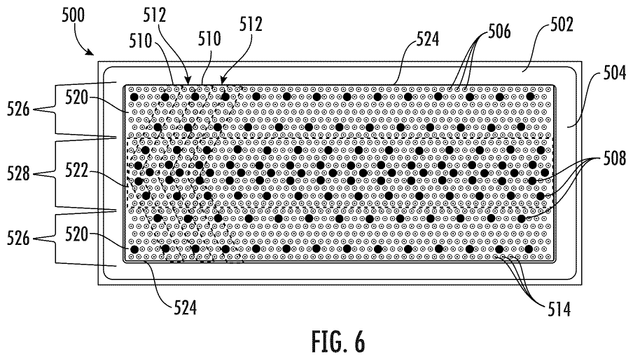

Referring to FIG. 6, tool body 502 defines a first outer section/portion 520 that is different than a second inner section/portion 522. In some embodiments, the first outer section/portion 520 is arranged along the periphery 524 such as along at least two sides 524 of the tool body 502. For example, the first outer section/portion 520 is arranged along the longer/wider sides 524 such that it surrounds the second inner section/portion 522 on at least two sides such as opposite sides. In a refinement, the first outer section/portion 520 is more proximate an outer perimeter 524 of the tool body 502 than the second inner section/portion 522. Alternatively, the first outer section/portion 520 may entirely surround the second inner section/portion 522.

In various embodiments, the first outer section/portion 520 has a first pattern and the second inner section 522 has a second pattern that is different than the first pattern. In one or more embodiments, the first outer section/portion 520 has an even/uniform/homogenous or uneven/non-uniform/non-homogenous distribution of dispensing apertures 514 forming a first plurality of dispensing apertures 526. In a variation, the second inner section/portion 520 has an even/uniform/homogenous or uneven/non-uniform/non-homogenous distribution of dispensing apertures 514 forming a second plurality of dispensing apertures 528. For example, the first outer section/portion 520 and the second inner section/portion 522 both have uneven/non-uniform/non-homogenous distributions of dispensing apertures 514 forming the first plurality of dispensing apertures 526 and the second plurality of dispensing apertures 528.

In one or more embodiments, the first outer section/portion 520 or the second inner section/portion 522 has a greater number of dispensing apertures 514 (i.e., a lower number of blocked aperture 508) and the other of the first outer section/portion 520 and the second inner section/portion 522 has a lower number of dispensing apertures 514 (i.e., a greater number of blocked apertures 508). For example, the first outer section/portion 520 has a greater number of dispensing apertures 514 (i.e., a lower number of blocked apertures 508) than the second outer section/portion 522 or vice versa i.e., the second inner section/portion 522 has a greater number of dispensing apertures 514 (i.e., a lower number of blocked apertures 508) than the first outer section/portion 520. In other words, the second inner section/portion 522 has a lower number of dispensing apertures 514 (i.e., a greater number of blocked apertures 508) or vice versa, i.e., the first outer section/portion 520 has a lower number of dispensing apertures 514 (i.e., a greater number of blocked apertures 508).

In various embodiments, the first plurality of apertures 526 or the second plurality of apertures 528 has more dispensing apertures 514 than the other of the first plurality of apertures 526 and the second plurality of apertures. For example, the first plurality of apertures 526 has more dispensing apertures 514 than the second plurality of apertures 528, or vice versa, i.e., the second plurality of apertures 528 has more dispensing apertures than the first plurality of apertures. Thus, a mesh member formed therefrom has either a harder surface region and softer core region, or a softer surface region and a harder core region.

For example, the first outer section/portion 520 or the first plurality of apertures 526 has at least 500 dispensing apertures 514, at least 600 dispensing apertures 514, or at least 700 dispensing apertures 514 and the second inner section/portion 522 or the second plurality of apertures 528 has no more than 550 dispensing apertures 514, no more than 500 dispensing apertures 514, or no more than 450 dispensing apertures 514. Alternatively, the second inner section/portion 522 or the second plurality of apertures 528 has at least 500 dispensing apertures 514, at least 600 dispensing apertures 514, or at least 700 dispensing apertures 514 and the first outer section/portion 520 or the first plurality of apertures 526 has no more than 550 dispensing apertures 514, no more than 500 dispensing apertures 514, or no more than 450 dispensing apertures 514. In a refinement, the first outer section/portion 520 has fewer blocked apertures 508 than the second inner section/portion 522. For example, the first outer section/portion 520 has no more than 50 blocked apertures, no more than 40 blocked apertures 508, or no more than 30 blocked apertures 508, and the second inner section/portion 522 has at least 50 blocked apertures 508, at least 60 blocked apertures, or at least 70 blocked apertures. Alternatively, the second inner section portion 522 has fewer blocked apertures 508 than the first outer section/portion 522. For example, the second inner section/portion 522 has no more than 50 blocked apertures, no more than 40 blocked apertures 508, or no more than 30 blocked apertures 508, and the first outer section/portion 520 has at least 50blocked apertures 508, at least 60 blocked apertures, or at least 70 blocked apertures.

In some embodiments, the first outer section/portion 520 or the first plurality of apertures 520 has at least 20% more dispensing apertures 514, at least 30% more dispensing apertures 514, at least 40% more dispensing apertures 514, at least 50% more dispensing apertures 514, or at least 60% more dispensing apertures 514 than the second inner section/portion 522 or the second plurality of apertures 528. In various embodiments, the second inner section/portion 522 has at least 50% more blocked apertures 508, at least 100% more blocked apertures 508, at least 150% more blocked apertures 508, at least 200% more blocked apertures 508, or at least 250% more blocked apertures 508. It should be understood that the first outer section/portion 520 is not merely larger/smaller than the second inner section/portion 522 such that it has more dispensing apertures 514 or fewer blocked apertures 508 but instead has a greater concentration of dispensing apertures 514 per unit area (i.e., the second inner section/portion 522 has a smaller concentration of dispensing apertures 514 per unit area). Alternatively, the second inner section/portion 522 or the second plurality of apertures 528 has at least 20% more dispensing apertures 514, at least 30% more dispensing apertures 514, at least 40% more dispensing apertures 514, at least 50% more dispensing apertures 514, or at least 60% more dispensing apertures 514 than the first outer section/portion 520 or the first plurality of apertures 526. In various embodiments, the first outer section/portion 520 has at least 50% more blocked apertures 508, at least 100% more blocked apertures 508, at least 150% more blocked apertures 508, at least 200% more blocked apertures 508, or at least 250% more blocked apertures 508.

In some embodiments, the first outer section/portion 520 may have an area equivalent to or only incrementally larger (e.g., less than 20% larger, less than 30% larger, less than 40% larger, less than 50% larger, or less than 60% larger). For example, the tool body 502 may have a total planar area of approximately 631.12 square centimeters with the first outer section/portion 520 accounting for approximately 384.16 square centimeters in the aggregate and the second inner section/portion 522 accounting for approximately 246.96 centimeters squared. However, despite being approximately 55.55% larger the first outer section/portion 520 (or the first plurality of apertures 526) has at least 60% more dispensing apertures 514, at least 65% more dispensing apertures 514, or at least 68% more dispensing apertures 514 than the second inner section/portion 522 (or the second plurality of apertures 528). In one or more embodiments, the first outer section/portion 520 has a concentration of at least 1.75 dispensing apertures 514 per square centimeter, or at least 1.80 dispensing apertures 514 per square centimeter, or at least 1.85 dispensing apertures 514 per square centimeter, or at least 1.88 dispensing apertures 514 per square centimeter whereas the second inner section/portion 522 has less than 1.75 dispensing apertures 514 per square centimeter, or no more than 1.74 dispensing apertures 514 per square centimeter. In some embodiments, the concentration of dispensing apertures 514 per unit area of the first outer section/portion 520 is at least 3% more, or 5% more, or 8% more than the concentration of dispensing apertures 514 per unit area of the second inner section/portion 522 (i.e., the concentration of dispensing apertures 514 per unit area of the second inner section/portion 522 is at least 3% less, or 5% less, or 8% less than the concentration of dispensing apertures 514 per unit area of the first outer section/portion 520).

Alternatively, the second inner section/portion 522 may have an area equivalent to or only incrementally larger (e.g., less than 20% larger, less than 30% larger, less than 40% larger, less than 50% larger, or less than 60% larger). However, despite being approximately 55.55% larger the second inner section/portion 522 (or the second plurality of apertures 528) has at least 60% more dispensing apertures 514, at least 65% more dispensing apertures 514, or at least 68% more dispensing apertures 514 than the first outer section/portion 520 (or the first plurality of apertures 526). In one or more embodiments, the second inner section/portion 522 has a concentration of at least 1.75 dispensing apertures 514 per square centimeter, or at least 1.80 dispensing apertures 514 per square centimeter, or at least 1.85 dispensing apertures 514 per square centimeter, or at least 1.88 dispensing apertures 514 per square centimeter whereas the first outer section/portion 520 has less than 1.75 dispensing apertures 514 per square centimeter, or no more than 1.74 dispensing apertures 514 per square centimeter. In some embodiments, the concentration of dispensing apertures 514 per unit area of the second inner section/portion 522 is at least 3% more, or 5% more, or 8% more than the concentration of dispensing apertures 514 per unit area of the first outer section/portion 520 (i.e., the concentration of dispensing apertures 514 per unit area of the first outer section/portion 520 is at least 3% less, or 5% less, or 8% less than the concentration of dispensing apertures 514 per unit area of the second inner section/portion 522).

In various embodiments, the first outer section/portion 520 or the first plurality of apertures 526 dispenses more flowable material by weight and/or volume than the second inner section/portion 522 or the second plurality of apertures 528 (i.e., the second inner section/portion 522 or the second plurality of apertures 528 dispenses less flowable material by weight and/or volume than the first outer section/portion 520 or the first plurality of apertures 526). In a refinement, a greater amount of flowable material by weight and/or volume is dispensed per unit area from the first outer section/portion 520 than from the second inner section/portion 522 (i.e., a lesser amount of flowable material by weight and/or volume is dispensed per unit area from the second inner section/portion 522 than from the first outer section/portion 520).

Alternatively, the second inner section/portion 522 or the second plurality of apertures 528 dispenses more flowable material by weight and/or volume than the first outer section/portion 520 or the first plurality of apertures 526 (i.e., the first outer section/portion 520 or the first plurality of apertures 526 dispenses less flowable material by weight and/or volume than the second inner section/portion 522 or the second plurality of apertures 528). In a refinement, a greater amount of flowable material by weight and/or volume is dispensed per unit area from the second inner section/portion 522 than from the first outer section/portion 520 (i.e., a lesser amount of flowable material by weight and/or volume is dispensed per unit area from the first outer section/portion 520 than from the second inner section/portion 522).

In one or more embodiments, the dispensing apertures 514 are arranged along the tool body to form a gradient with the least dispensing apertures 514 per unit area at a central region and the most dispensing apertures 514 per unit area at a peripheral region. Thus, a gradient of flowable material dispensed from the tool body is formed with the most flowable material by weight and/or volume per unit area flowing from an outer peripheral region and the least flowable material by weight and/or volume per unit area flowing from an inner central region). In a variation, the concentration of dispensing apertures per unit area increases from a central region to an outer peripheral region. In a refinement, this gradient is present in the first outer section/portion 520 and/or the second inner section 522 such that an outer portion of the section dispenses more flowable material and/or has more dispensing apertures 514 per unit area than an inner portion of the section. Said differently, the first plurality of apertures 526 is arranged such that a more central portion of the first outer section/portion 520 dispenses less flowable material and/or has fewer dispensing apertures 514 per unit area than an outer portion of the first outer section/portion 520 (i.e., a portion more proximate the outer perimeter 524 dispenses more flowable material and/or has more dispensing apertures 514 per unit area than an inner portion of the first outer section/portion 520), and the second plurality of apertures 528 is arranged such that a more central portion of the second inner section/portion 522 dispenses less flowable material and/or has fewer dispensing apertures 514 per unit area than an outer portion of the second inner section/portion 522 (i.e., a portion more proximate the outer perimeter 524 dispenses more flowable material and/or has more dispensing apertures 514 per unit area than an inner portion of the second inner section/portion 522).

Alternatively, the dispensing apertures 514 are arranged along the tool body 502 to form a gradient with the most dispensing apertures 514 per unit area at a central region and the least dispensing apertures 514 per unit area at a peripheral region. Thus, a gradient of flowable material dispensed from the tool body 502 is formed with the least flowable material by weight and/or volume per unit area flowing from an outer peripheral region and the most flowable material by weight and/or volume per unit area flowing from an inner central region). In a variation, the concentration of dispensing apertures per unit area decreases from a central region to an outer peripheral region. In a refinement, this gradient is present in the first outer section/portion 520 and/or the second inner section 522 such that an inner portion of the section dispenses more flowable material and/or has more dispensing apertures 514 per unit area than an outer portion of the section. Said differently, the first plurality of apertures 526 is arranged such that a more peripheral portion of the first outer section/portion 520 dispenses less flowable material and/or has fewer dispensing apertures 514 per unit area than an inner central portion of the first outer section/portion 520 (i.e., a portion more proximate the center dispenses more flowable material and/or has more dispensing apertures 514 per unit area than an outer peripheral portion of the first outer section/portion 520), and the second plurality of apertures 528 is arranged such that a more peripheral portion of the second inner section/portion 522 dispenses less flowable material and/or has fewer dispensing apertures 514 per unit area than an inner central portion of the second inner section/portion 522 (i.e., a portion more proximate the center dispenses more flowable material and/or has more dispensing apertures 514 per unit area than a peripheral portion of the second inner section/portion 522).

Referring to FIGS. 8-9, a mask/template 800 may cooperate with the tool body 502 such as by being overlayed, fastened, affixed, secured, or otherwise disposed on/adjacent the tool body 502 to block certain apertures 506 thereby creating blocked apertures 508. In one or more embodiments, the mask/template 800 defines an outer profile 802 in the shape of a cushion such as a seat cushion 32, 42, or 100. For example, the cushion is a seat bottom cushion, seat back cushion, headrest cushion, or armrest cushion. In one or more embodiments, the mask/template 800 has one or more (e.g., a plurality of) bridges 804 defining a plurality of open spaces 806. In a variation the bridges 804 may extend across portions of the outer profile 802 and/or intersect with one or more other bridges 804.

With the above process, the cushion 900, as shown in FIG. 9, may be formed of a set of filaments 52, wherein at least two members of the set of filaments 52 are looped and/or bonded to each other. In one or more embodiments, each member of the set of filaments 52 is looped and/or bonded to at least one other member of the set of filaments. In some embodiments, the mesh member or cushion 900 defines a first side 906 and a second side 908 opposite the first side 906. In one or more embodiments, the cushion/mesh member 900 includes a plurality of first sections 902 and a second section 904 with each of the plurality of first sections 902 being different than the second section 904. In various embodiments, the plurality of first sections 902 has a lower density than the second section 904 and the second section 904 has a higher density than the plurality of first sections 902. In a refinement, the plurality of first sections 902 has less thermoplastic material per unit volume than the second section 904 (i.e., the second section 904 has more thermoplastic material per unit volume than the plurality of first sections 902). In a variation, the plurality of first sections 902 has fewer filaments per unit volume than the second section 904 (i.e., the second section 904 has more filaments per unit volume than the plurality of first sections 902). In a one or more embodiments, each section of the plurality of first sections 902 and the second section 904 extend from the first side 906 to the second side 908. In one or more embodiments, the first sections 902 are intermittently dispersed throughout the second section 904 such as shown in FIGS. 4-6. In a refinement, the plurality of first sections 902 having lower density are uniformly dispersed through the second (higher density) section 904. As shown in FIG. 9, the filaments, although, bonded, looped and entangled generally define an extrusion direction (DE) and the plurality of first sections 902 form lower density columns extending along the extrusion direction (DE).

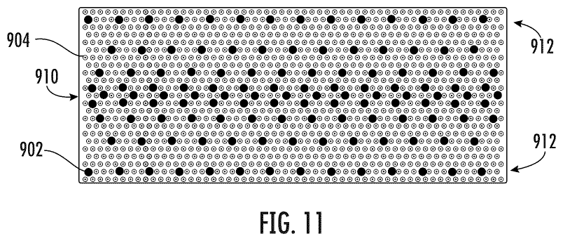

Referring to FIG. 11, a central portion 910 of the cushion/mesh member 900 has a plurality of lower density sections 902. In a refinement, the central portion 910 has a greater number of lower density sections 902 than an outer peripheral region 912 such that the central portion 910 has a lower density than the outer peripheral region 912. In various embodiments, the plurality of first sections 902 is proximate a central region 910 of the cushion/mesh member 900. In some embodiments, the plurality of lower density sections 902 form a gradient with the greatest number of lower density sections 902 at or proximate the central region 910 such that the number of lower density sections 902 decreases as you move further away from the central region 910 and more proximate the outer/peripheral region 912. In other words, the central region 910 has more lower density sections 902 than the outer/peripheral region 912 (i.e., the outer region 912 has fewer lower density sections 902).

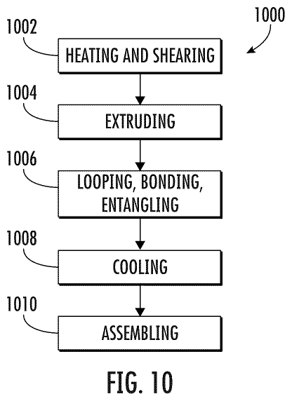

Referring to FIG. 10, a method 1000 of producing a mesh member and/or a vehicular seat is disclosed. The method 1000 includes one or more of the following steps: heating and/or shearing a thermoplastic material into a flowable molten material (i.e., step 1002), extruding the flowable molten material through one or more of the die plates (e.g., tool bodies) described herein to form a plurality of thermoplastic filaments (i.e., step 1004), looping, bonding, and entangling the plurality of thermoplastic filaments (i.e., step 1006), cooling the plurality of thermoplastic filaments after looping, bonding, and entangling to form one or more mesh members/cushions as described herein (i.e., step 1008), and assembling the one or more mesh members/cushions into a seat assembly such as for a vehicle (i.e., step 1010). In various embodiments, the method 1000 employs one more aspects of the manufacturing system 60, as described above and shown in FIG. 3, for heating, shearing, extruding, looping, bonding, entangling, and cooling.

According to a first aspect, a cushion assembly such as for a vehicular seat comprises a mesh member comprising a set of filaments of thermoplastic material and each member of the set of filaments is looped and bonded to at least one other member of the set of filaments. The mesh member also defines a plurality of lower density sections disposed within a higher density section.

According to a second aspect, the plurality of lower density sections of the first aspect or any of the following aspects each comprise less thermoplastic material per unit volume than the higher density section.

According to a third aspect, each lower density section of the plurality of lower density sections of any of the previous or following aspects comprises fewer filaments per unit volume than the higher density section.

According to a fourth aspect, each lower density section of the plurality of lower density sections of any of the previous or following aspects extends from a first end of the mesh member to an opposite second end of the mesh member.

According to a fifth aspect, the plurality of lower density sections of any of the previous or following aspects is located proximate a central region of the mesh member.

According to a sixth aspect, the plurality of lower density sections of any of the previous or following aspects forms a gradient comprising a greater quantity of lower density sections proximate a central region and a lower quantity of lower density sections proximate a peripheral region.

According to a seventh aspect, the plurality of lower density sections of any of the previous or following aspects is intermittently dispersed throughout the higher density section.

According to an eighth aspect, the plurality of lower density sections of any of the previous or following aspects is uniformly dispersed throughout the higher density section.

According to a nineth aspect, a central portion of the mesh member of any of the previous or following aspects has a lower density per unit of volume than a peripheral portion of the mesh member.

According to a tenth aspect, a seat assembly comprises a frame supporting the cushion assembly of any of the previous or following aspects.

According to an eleventh aspect, a tool comprises a tool body comprising a plurality of first sections and a plurality of second sections arranged such that each second section is intermittently disposed adjacent one or more first sections. The tool body defines a plurality of apertures to dispense a flowable material and the plurality of apertures is arranged to dispense a flowable material through each section with a greater amount of flowable material dispensed from the plurality of first sections relative to the plurality of second sections.

According to a twelfth aspect, the plurality of first sections of any of the previous of following aspects defines a higher concentration of apertures per unit area than the plurality of second sections.

According to a thirteenth aspect, the plurality of second sections of any of the previous or following aspects defines blocked apertures that do not dispense the flowable material.

According to a fourteenth aspect, a mask overlays the tool body of any of the previous or following aspects to block the blocked apertures.

According to fifteenth aspect, each section of the plurality of first sections of any of the previous or following aspects comprises an area equivalent to each second section.

According to a sixteenth aspect, the plurality of apertures of any of the previous or following aspects is uniformly arranged in the plurality of first sections and non-uniformly arranged within the second plurality of sections.

According to a seventeenth aspect, a tool comprises a tool body comprising a first section more proximate an outer perimeter of the tool body than a second section. The first section defines a first plurality of apertures to dispense a flowable material and the second section defines a second plurality of apertures such that the first section is arranged to dispense a greater amount of the flowable material per unit area through the first plurality of apertures than through the second plurality of apertures of the second section.

According to an eighteenth aspect, the first section of any of the previous or following aspects surrounds the second section.

According to a nineteenth aspect, the second plurality of apertures of any of the previous or following aspects is arranged such that a center portion of the second section dispenses less flowable material than an outer portion of the second section.

According to a twentieth aspect, the apertures of the second plurality of apertures are arranged in a gradient from an inner portion to an outer portion.

While exemplary embodiments are described above, it is not intended that these embodiments describe all possible forms encompassed by the claims. The words used in the specification are words of description rather than limitation, and it is understood that various changes can be made without departing from the scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An assembly comprising:
a mesh member comprising a set of filaments of thermoplastic material wherein each member of the set of filaments is looped and bonded to at least one other member of the set of filaments, the mesh member defining a plurality of lower density sections disposed within a higher density section.

2. The assembly of claim 1, wherein the plurality of lower density sections each comprise less thermoplastic material per unit volume than the higher density section.

3. The assembly of claim 1, wherein each lower density section of the plurality of lower density sections comprises fewer filaments per unit volume than the higher density section.

4. The assembly of claim 1, wherein each lower density section of the plurality of lower density sections extends from a first end of the mesh member to an opposite second end of the mesh member.

5. The assembly of claim 1, wherein the plurality of lower density sections is located proximate a central region of the mesh member.

6. The assembly of claim 1, wherein the plurality of lower density sections forms a gradient comprising a greater quantity of lower density sections proximate a central region and a lower quantity of lower density sections proximate a peripheral region.

7. The assembly of claim 1, wherein the plurality of lower density sections is intermittently dispersed throughout the higher density section.

8. The assembly of claim 1, wherein the plurality of lower density sections is uniformly dispersed throughout the higher density section.

9. The assembly of claim 1, wherein a central portion of the mesh member has a lower density per unit of volume than a peripheral portion of the mesh member.

10. A seat assembly comprising a frame supporting the assembly of claim 1.

11. A tool comprising:
a tool body comprising a plurality of first sections and a plurality of second sections arranged such that each second section is intermittently disposed adjacent one or more first sections, the tool body defining a plurality of apertures to dispense a flowable material, the plurality of apertures arranged to dispense a flowable material through each section, a greater amount of flowable material dispensed through the plurality of first sections relative to the plurality of second sections.

12. The tool of claim 11, wherein the plurality of first sections defines a higher concentration of apertures per unit area than the plurality of second sections.

13. The tool of claim 11, wherein the plurality of second sections defines blocked apertures that do not dispense the flowable material.

14. The tool of claim 13, further comprising a mask overlaying the tool body, the mask blocking the blocked apertures.

15. The tool of claim 11, wherein each section of the plurality of first sections comprises an area equivalent to each second section.

16. The tool of claim 11, wherein the plurality of apertures is uniformly arranged in the plurality of first sections and non-uniformly arranged within the second plurality of sections.

17. A tool comprising:
a tool body comprising a first section more proximate an outer perimeter of the tool body than a second section, the first section defining a first plurality of apertures to dispense a flowable material and the second section defining a second plurality of apertures such that the first section is arranged to dispense a greater amount of the flowable material per unit area through the first plurality of apertures than through the second plurality of apertures of the second section.

18. The tool of claim 17, wherein the first section surrounds the second section.

19. The tool of claim 17, wherein the second plurality of apertures is arranged such that a center portion of the second section dispenses less flowable material than an outer portion of the second section.

20. The tool of claim 17, wherein the apertures of the second plurality of apertures are arranged in a gradient from an inner portion to an outer portion.
